(19) United States
(12) Patent Application Publication
(10) Pub. No.: US 2006/0020574 A1
(43) Pub. Date: Jan. 26, 2006

(54) Area optimization of hardware for algorithms by optimizing sizes of variables of the algorithm

(75) Inventors: Rajat Moona, Kanpur (IN); Russell Alan Klein, West Linn, OR (US); Ramachandran Gopalakrishnan, Hyderabad (IN)

Correspondence Address: KLARQUIST SPARKMAN, LLP, 121 SW SALMON STREET, SUITE 1600, PORTLAND, OR, 97204, US

(73) Assignee: Mentor Graphics Corporation

(21) Appl. No.: 10/896,630

(22) Filed: Jul. 21, 2004

(51) Int. Cl. G06F 17/30

(52) U.S. Cl. 707/2

(57) ABSTRACT

Described herein are methods and systems for optimizing area related to hardware implementation of algorithms. The algorithms may be related to functionality of an embedded system, for instance. System functionality may be initially implemented in software and converted to hardware implementation. Prior to implementing system functionality in actual hardware, algorithms for selected system functionality or desirable all system functionality may be evaluated to determine values attained by selected variables or desirably all the variables comprised therein. In one embodiment, a probe may applied to the original software code to determine a maximum value and a minimum value corresponding to each of the variables of the algorithm (or at least one such variable) may be tracked across one or more invocations of functions (or other code components) of the algorithm comprising such variables. Based on such tracked values, a minimum size (e.g., in bit-width), for each of the variables, needed to express the various values attained by the variables may be determined. The original software code implementing system functionality may then be modified to declare or otherwise specify an optimal (e.g., the minimum bit-width needed to express values attained) bit-width, which can result in reduced area for a hardware implementation.

### TECHNICAL FIELD

The field relates to design of circuits. More particularly, the field relates to methods of designing circuits for optimal use of circuit resources.

### BACKGROUND

An electronic system may comprise both software components and hardware components. Software components may comprise software program modules implemented in a high-level software programming language such as C, C++ or Pascal. Software components may also comprise program modules initially implemented in an assembly language such as, IA-32 (Intel® architecture 32-bit) and IA-64 (Intel® architecture 64-bit). Hardware components may comprise at least one general purpose processor (e.g., an Intel® x86 architecture processor) for executing the software components, memory (e.g., random access, hard disk or read only) and other hardware components (e.g., field programmable gate arrays (FPGA) or other programmable logic, application specific integrated circuits (ASIC) or System on Chip (SOC)). The design of such an electronic system may begin with an implementation of the system functionality in a software programming language (e.g., C, C++ or Pascal). Alternatively, the system components initially may be implemented in an assembly language (e.g., IA-32 or IA-64). However, depending on design objectives, it may be beneficial to migrate selected functionality of the system in to actual hardware (e.g., as FPGAs or other programmable logic, ASIC or SOC).

System designers implementing the electronic system's functionality originally in a software program do not typically concern themselves with selecting the size (e.g., by specifying a size of values associated with the variable in units of memory such as bits) of variables that may be used in software components implementing the electronic system functionality. Indeed, most ordinary software programming languages (e.g., C, C++ or Pascal) do not provide for methods of selecting the size of variables declared to be used in a software program. Furthermore, in most circumstances the size of variables in a software program is a function of the target central processing unit (CPU) architecture to which the program may be compiled.

However, when such software programs (e.g., in C, C++ or Pascal) are converted to a hardware implementation (e.g., as FPGAs or other programmable logic, ASIC or SOC) the size of the variables is a significant factor that affects the amount of hardware resources needed to implement the particular system functionality. In general, the amount or quantity of hardware resources may be specified in terms of the surface area of the actual hardware devices (e.g., FPGAs or other programmable logic, ASIC or SOC). In a hardware implementation, each variable is typically implemented as a wire, a flip flop or other registers. Hence, the size of variables (e.g., in bit-width) directly affects the register area, if the variable is converted to a register. Also, a variable may be used as an operand in logical or mathematical operations such as multiplication or addition. Hence, the variable size may indirectly affect the area needed to implement hardware functional units implementing such logic or mathematical operations using the variable.

In most designs, the hardware area related to implementing components such as multipliers, dividers and shifters can be drastically reduced if appropriate sizes are specified for the program variables.

### BRIEF DESCRIPTION OF THE DRAWINGS

FIG. 1 is a flow diagram describing an exemplary overall method for achieving area optimization for hardware implementation of algorithms by determining optimal sizes for at least one of the variables of the algorithm.

FIG. 2 is a flow diagram describing an exemplary method for using probes to record values attained by the various variables of an algorithm in order to determine their optimal sizes.

FIG. 3 is diagram illustrating an exemplary apparatus for compiling software program code into probe applied software program code for recording values attained by at least one of the variables of an algorithm implemented in the code in order to determine its optimal size.

FIG. 4 is diagram illustrating an exemplary apparatus for generating a report with hints with suggested optimal sizes of at least one of the various variables of an algorithm.

FIG. 4A is a diagram illustrating an exemplary apparatus for generating a register analyzer model from a software code representation.

FIG. 4B is a diagram illustrating an exemplary apparatus for executing the register analyzer in conjunctions with stimulus data and a probe function library for generating a bit-width report.

FIG. 5 is a diagram illustrating an exemplary client-server network environment.

FIG. 6 is a diagram illustrating an exemplary implementation of methods of area optimization by optimally specifying variable sizes in a client-server environment.

### DETAILED DESCRIPTION

The disclosed invention is directed toward novel and unobvious features and aspects of the embodiments of the system and methods described herein. The disclosed features and aspects of the embodiments can be used alone or in various novel and unobvious combinations and sub-combinations with one another.

Although the operations of the disclosed methods are described in a particular, sequential order for convenient presentation, it should be understood that this manner of description encompasses rearrangements, unless a particular ordering is required by specific language set forth below. For example, operations described sequentially may in some cases be rearranged or performed concurrently. Moreover, for the sake of simplicity, the disclosed flow charts and block diagrams typically do not show the various ways in which particular methods can be used in conjunction with other methods. Additionally, the detailed description sometimes uses terms like “determine” to describe the disclosed methods. Such terms are high-level abstractions of the actual operations that are performed. The actual operations that correspond to these terms will vary depending on the particular implementation and are readily discernible by one of ordinary skill in the art.

Some of the methods described herein can be implemented in software stored on a computer-readable medium and executed on a computer. Some of the disclosed methods, for example, can be implemented as part of an electronic design automation (EDA) tool. Such methods can be executed on a single computer, on a networked computer or a network of computers. For clarity, only those aspects of the software germane to these disclosed methods are described; product details well-known in the art are omitted. For the same reason, the computer hardware is not described in further detail.

As noted above, most software programmers are not typically concerned with selecting variable sizes since it is usually a function of the target CPU architecture. Furthermore, most programming languages do not provide for methods for selecting variables sizes. Thus, it would be desirable to selectively specify the size (e.g., in bit-width) of at least one and desirably all of the variables in a software program that may eventually be converted to a hardware implementation of an electronic system's functionality. More particularly, it may desirable to evaluate software program code implementation of a system functionality to determine sizes of the various variables used and specifying the optimal sizes of at least some of the variables based on the evaluation. In this manner, the area of the hardware needed to implement the system functionality originally implemented in software may be optimized. Area optimization may be achieved by any reduction in the size of at least one of the program variables in comparison to what may have been a default size (e.g., set in bit-widths depending on the target CPU).

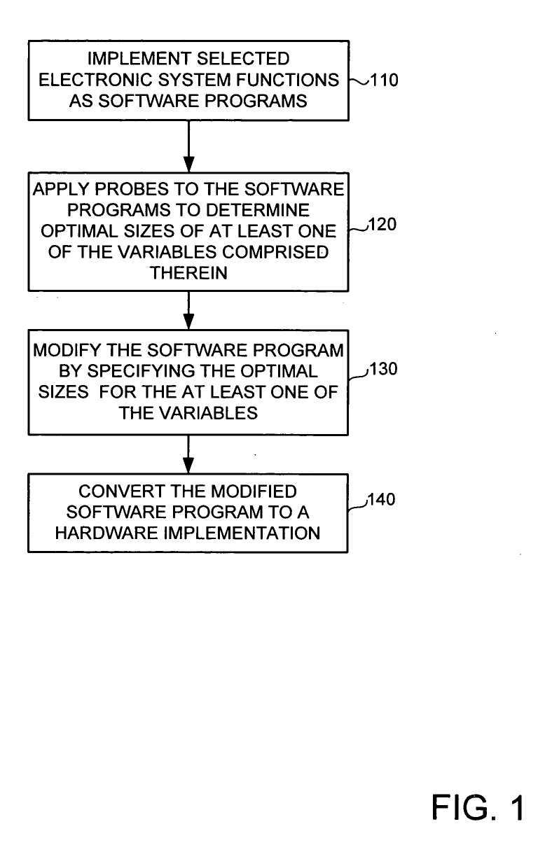

FIG. 1 illustrates an exemplary method for optimizing area of a hardware implementation of selected system functions by specifying optimal sizes for function variables. At 110, selected system functions may be initially implemented as software program code in a software programming language (e.g., C, C++ or Pascal). At 120, probes may be appropriately applied to determine optimal sizes (e.g., in bit width) for at least one and desirably all of the variables within the software program. The probes may be implemented as software code adapted to monitor the execution of the software program being probed by maintaining data structures used for recording the various values attained by selected variables of the software program.

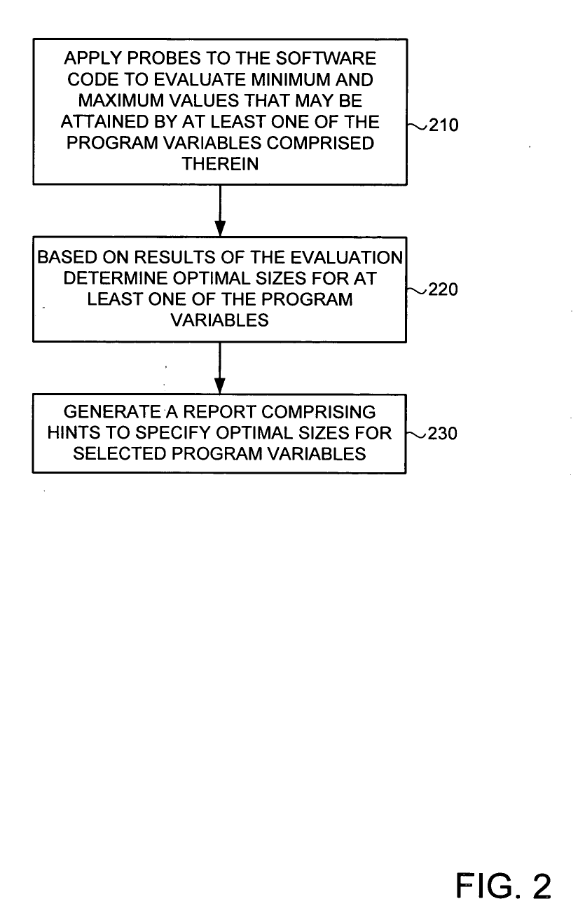

For instance, as described in FIG. 2 at 210, code related to the probes may maintain a record of at least a minimum value and a maximum value and desirably a current value attained for at least one of the program variables. Such data regarding values attained by program variables may be selectively recorded. Thus, not all variables of the program need to be monitored or recorded. Nevertheless, for those program variables being evaluated, optimal sizes may be determined. For instance, if a software program Foo is as follows:

Foo { char *x, int a, int b, int c;
For (a = 0, a ≦ 4; a++)
b = b + x[a]
}

A conventional compiler depending on the target CPU architecture may designate the size of variables a, b and c in default bit-widths such as 32 bits or 64 bits. However, a probe evaluating the software code may determine that the minimum value of variable “a” will be 0 and is maximum value will be 4. Hence, according to the code listed above, a bit-width of 3 may be sufficient to express all possible values that may be attained by the variable “a.” Also, bit-widths greater than 3 bits (e.g., such as 32 bits or 64 bits that may be a default width) may be unnecessary. Thus, any reduction of bit-widths in comparison to such defaults may result in area savings once the software program is implemented in actual hardware. A record of minimum and maximum values of a program variable may be maintained in terms of a maximum absolute value attained and a sign (e.g., − or +) associated with such a value.

At 220 in FIG. 2, based on results of such evaluation, optimal sizes for at least some, and desirably all of the various program variables may be determined. At 230, a report may be generated to indicate a minimum value and a maximum value attained by selected variables. Additionally, the reports may comprise an original size (e.g., in bit-width) and hints comprising suggestions of optimal sizes (e.g., in bit-width) for the selected program variables. In one embodiment, the optimal sizes may be the minimum number of bits needed to express the values attained by the selected program variables. Alternatively, besides the minimum bit-widths needed to express values of the program variables, other rules may be combined to compute a hint comprising suggested optimal bit-widths other than the minimum bit-widths.

Later, at 130 in FIG. 1, the report may be reviewed to determine which of the hints are useful and the original software code may be modified to specify optimal sizes (e.g., in bit-width). Then at 140, the software code with size of program variables optimally specified may be converted to a hardware implementation using synthesis tools. Depending on the optimal sizes (e.g., in bit-width) chosen, the resulting actual hardware may have a reduced area when compared to actual hardware implemented from synthesis of the original software program code without the optimal variable sizes specified (e.g., as may be based on default sizes).

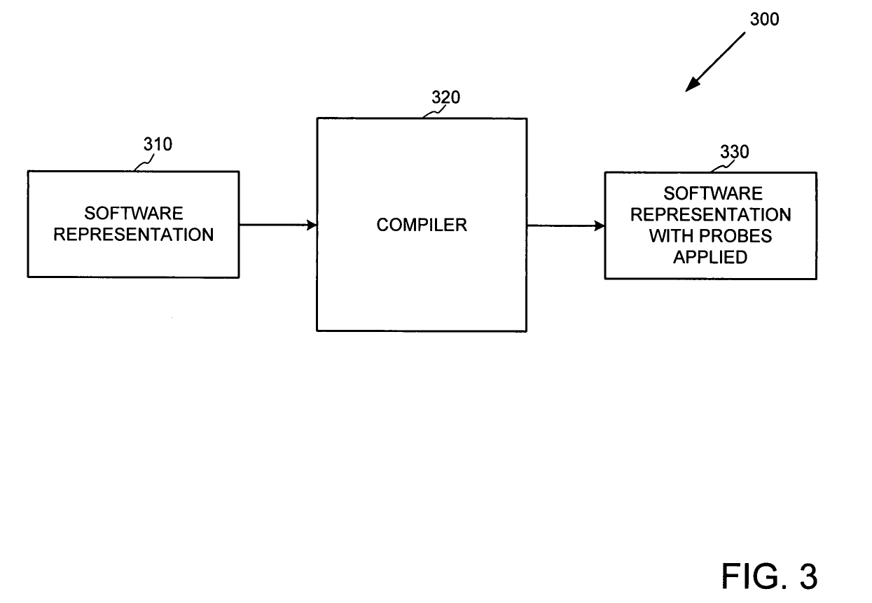

FIG. 3 illustrates an exemplary system 300 for applying probes to a software code representation 310 of system functions. In one example, the software code representation may be compiled by a compiler 320 and code related to probes may be inserted appropriately to record the values attained by the various variables of the software code representation 310. The result of such compilation may be a version of software code representation with probes applied at 330.

For instance, assume software code representation of an exemplary system function Foo is as follows:

int Foo (int array *x, int a, int v) {
int temp;
temp = x[a];
x[a] = v;
return temp;
}

In one embodiment, such a software code representation may be converted to another software code representation with probes applied. The probes may monitor the various memory write and read operations expressed within the original code by recording values of the program variables during execution. Thus, in one example, the exemplary software code representation of system function Foo may be compiled to a probe applied version by inserting probe functions as follows:

rec-int Foo’ (rec-int array *x, rec-int a, rec-int v) {
rec-int temp;
set (temp, get-mem (x, get (a));
set mem (x, get (a), get(v));
return temp;
}

Thus, as shown above, the various instructions related to memory read and write operations are converted to probe functions such as get( ), set( ), get mem( ) and set mem( ). Such syntax is only exemplary. However, in the exemplary probe function set (temp, get-mem (x, get (a)) above, the variable temp is assigned a new value read from the memory location related to array element x[a]. Thus, in addition to assigning the new value to this variable “temp,” the set (temp, get-mem (x, get (a)) function may also update a data structure comprising a minimum value and a maximum value. Thus, if temp in one invocation of the function Foo attained a value −10 and if that is the lowest value attained so far across all invocations of the function Foo then the minimum value field is updated to −10. Likewise, a maximum value field may be updated upon encountering a highest value attained so far for the variable temp across all invocations of function Foo. Alternatively, minimum and maximum values may be recorded in terms of absolute values and associated signs.

In this manner, at any given time the probe related data structures recording the values of the variables of interest in a software program can be updated with the maximum and minimum values attained for the variables of interest in a program. This can be translated to optimal bit-widths needed to store the possible values of the selected variable. For instance, if the temp attains a minimum value of 255 but a maximum value of 65280 then a bit-width of 16 may be sufficient to express all possible values of the variable “temp.”

As such, if a 32 bit size was assigned to such a variable as a default, specifying a size of 16 bits would result in substantial area savings if a function comprising such a variable is migrated to hardware. To specify a variable size (e.g., as 16 bits), the declaration of an ordinary variable may be modified as follows:
unsigned int# 16 temp;

Again, these are just exemplary syntax and methods disclosed are not limited to such syntax.

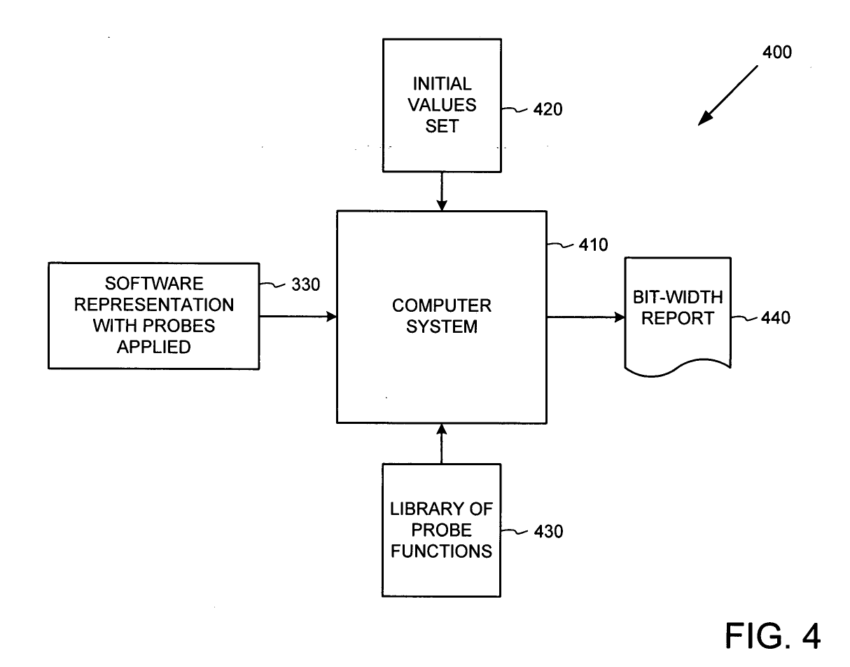

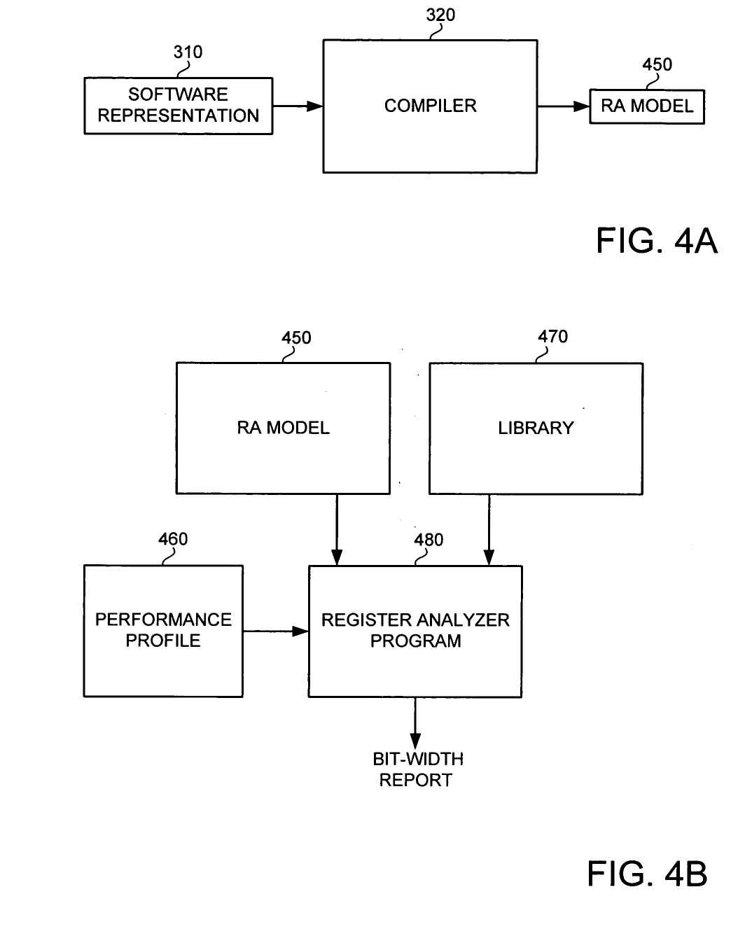

FIG. 4 illustrates an exemplary system 400 for determining optimal sizes (e.g., in bit-widths) for variables of a program by applying probe functions to a software program to record values attained by variables of interest in a program. The software representation of programs applied with probes for determining optimal size for variables 330 may be executed in a general purpose computer system 410. Code related to the functionality of probe functions such as set( ) and get( ) may be provided via a library such as the one at 430 and linked to the software representation with probes 330 for execution. Such libraries are just exemplary implementations. Alternatively, the probe function calls including any code related to their functionality may be directly inserted into the software representation applied with probes 330 (for instance, as sub-routines).

In one embodiment, only selected functions of a system may be monitored for determining optimal sizes of their variables. Thus, data related to execution of rest of the system functions may be provided as an initial value set 420 that may drive the program being monitored by the way of providing such a program with parameters it may expect from outside the function, for instance. Such test bench data may be collected by initially modeling the system functionality to generate a performance profile of the system including data such as input data, output data, memory transaction data and bus transaction data.

Further information regarding methods and systems for generating a performance profile of an electronic system may be found in the published U.S. application Ser. No. 10/295,538 filed Nov. 15, 2002 (U.S. Pub. No. US-2004-0098701-A1, published May 20, 2004) which is incorporated herein by reference. Additional details related to the same may be found in the published U.S. application Ser. No. 10/295,538 also filed Nov. 15, 2002 (U.S. Pub. No. US-2004-0098701-A1, published May 20, 2004), which is incorporated herein by reference. These methods are just exemplary, in fact other methods of providing data 420 needed to drive the execution of the software representation 330 may be used.

Upon execution of software code representation with probes 330 a report 440 may be generated to indicate data related to values attained by variables of the software code 330. The report may comprise a minimum value attained and a maximum value attained and desirably a current value. The report may also comprise hints comprising suggested sizes for at least one and desirably all of the program variables of interest. Thus, a user or another system may examine the hint and in light of other data obtained from the rest of the system or examining the code itself, specify an optimal size for selected variables. In embodiment, specification of an optimal size based on hints within the report may be automatic.

In one exemplary approach, an original software code representation of a system function is first transformed into a modified software code representation, called a Register Analyzer (RA) model (FIG. 4A). The RA model may then be compiled and linked with a statically provided library, to create an executable program (FIG. 4B). This program, when executed may get its inputs from a performance profile and create a report comprising suggested sizes (e.g., in bit-width) of selected variables. The performance profile may created by executing the original software code representation and it may contain the execution and memory accesses, and function call traces related to the software code representation.

The RA model may be implemented as a program in a software programming language (e.g., C) that represents the behavior of the original software code representation. It is created by parsing the original software code and converting it to modified code. In the modified code, for instance, the read and write access to each variable of the program may be transformed to call to bit-width probe functions such as, ‘get’ and ‘set’ respectively. The “get” and “set” functions may be implemented within a library. In one embodiment “set” functions may maintain a record of the maximum and minimum values of a variable, and update the record, when a variable is updated. Also, in one embodiment, the “get” function returns the current value of a variable. Similarly, data reference using pointers is transformed into call to library functions “getmem” and “setmem” respectively. In the modified code of the RA model 450 (FIG. 4A), function calls may be inlined and arithmetic operations may be redefined.

Also, variables may be converted to data structure for recording the various values attained by the various variables of the original software code. In one embodiment value related information about one variable, regardless of its type or scope, is stored in one element of the data structure.

In one embodiment of such an exemplary data structure, the following fields may be included in a data structure element:
A name of the variable.
A filename and line number corresponding to the variable declaration
A current value associated with the variable
A maximum and minimum values assumed by the variable so far. Note that only 1 maximum (or minimum) may be needed even for array variables, since the array element size will depend on the maximum value assumed by any one of the array elements.
A declared bit width for the variable: For array variable, it is the bit width of the array element
A flag to indicate if the current value is valid or not. A value is valid, if the variable has been assigned at least once within the code being evaluated.
One or more flags to indicate if the minimum and maximum values are valid.

As noted above, system functions being evaluated for determining optimal bit-widths of variables may need data stimulus from outside the functions being evaluated. This may be provided by a performance profile (e.g., 460 in FIG. 4B). The performance profile may be created while executing an original software representation of the system functionality. The profile 460 may comprise records of execution, memory transactions and function calls. The profile may also comprise a set of records, each of which comprises a “time” field indicating the time of occurrence of the event (e.g., memory access or entry to a function). An exemplary performance profile may comprise the follows:
Function Entry record—Created when a function is entered and comprising an invocation identifier and the function name.
Function Exit record—Created while exiting a function and comprising an invocation identifier and the return value.
Function Parameter record—Created for each parameter of a function that is called and comprising an invocation identifier, a parameter name and the parameter value.
Memory Record—Comprising an address, data, size of the access, and attribute (e.g., read, or write).

The performance profile (e.g., 460) may be used to provide the input (or stimulus) to the Register Analyzer Model. The stimulus for scalar parameters may be provided using a value stored in the Function parameter record.

With regard to array parameter, the function parameter record comprises address of the 1st array element, and it may be used to compute the address of each array element. The value of the array element may be found by searching the Memory records, for the particular function invocation. The first memory record for the array element access after the function entry time may be the stimulus.

The performance profile (e.g., 460) also may be used to verify the response related execution of a system function being evaluated. Thus, a return value of a function may be stored in the Function Exit record. The elements of an array can be modified within the function. Thus, a final value of an array element can be determined by searching the memory record, for a particular function invocation. The final value will be the last memory record for the array element access prior to function exit time.

In one embodiment, a library (e.g., 470 in FIG. 4A) may comprise code related to probe functions such as “set”, “get”, “setmem” and “getmem.” The library may comprise the following exemplary functions:
typedef long long intlimit_t;
intlimit_t get(integer_info_t*p, int index)

The “get” function returns the current value for the variable represented by the array element “p.” The “index” represents the array index for array variables and is 0 for scalars.
void set(integer_info_t *p, int index, intlimit_t value)

The “set” function sets the current value for the variable represented by the array element “p” to “value.” The “index” represents the array index for array variables, and is 0 for scalars.
intlimit_t getmem(int address, int size)
void setmem(int address, int size, intlimit_t value)

The “getmem” and “setmem” functions are used to perform the pointer dereference operations.
int fentry(char *function_name)

The “fentry” function reads the performance profile (e.g., 460) and finds the next invocation of the function specified in “function\_name.”
out_scalar(integer_info_t *p, char *name);

The “out\_scalar” function will determine the stimulus for a scalar function parameter “name” from the performance profile, and update the value in “p.”
out_array_scalar(integer_info_t*p, char *name, int size);

The “out\₁₃ array\_scalar” function will determine the stimulus for an array function parameter ‘name’ from the performance profile, and update the value in “p” and “size” is the array dimension.
in_ret(integer_info_t*p, char*name);

The in\_ret” function will check the return value in the performance profile with that in the variable represented by “p.”
in_array_scalar(integer_info_t*p, char*name, int size);

The “in\_ret\_array\_scalar” function will check the value in the array parameter “name” in the performance profile with the value of the variable in “p” and “size” is the array dimension.

In one embodiment, the exemplary bid-width executable program (e.g., 480 in FIG. 4B) may call a function (e.g., part of RA model 450) to initialize the static and global variables in the original software code representation of the system function. The executable program 480 calls a library function “fentry”, to search the performance profile for an invocation of the specified function. If an invocation is found, program 480 calls a software driver function to execute the RA model. This step may be repeated as long as a “fentry” functions finds a new invocation. Later, the program 480 calls a library function to print the report containing the bit width for at least one and desirably all variables, computed across at least some and desirably all function invocations.

For instance, consider the following exemplary software code related to original implementation of a system function “foo.”
int foo(int a, int b[10]) {
static int sum=0; int i;
for(i=0; i<10; i++)
sum+=a*b[i];
return sum;}

Some of the variables declared by the RA model 450 may inlcude:
intlimit\_t value\_{—}2[1], value\_{—}4[10];

These will be used to store the current value associated with ‘sum’ and ‘b’ respectively.
char valid\_{—}2[1], valid\_{—}4[10];

These will be used to indicate the validity of the current value of ‘sum’ and ‘b’ respectively.

Similarly, ‘valid’ and ‘value’ variables are declared in the RA model for the remaining variables in the original C function and any compiler generated temporaries. An array, ‘integer\₁₃ info\_g’ of type integer\_nfo\_t, is initialized with all the fields for each variable. The size of the array is also initialized.

The RA model for the example above may comprise definitions as follows:

```
#define foo_plusplus_0 †
  (void *)(&integer_info_g[0])
#define foo_i_1 (void *)(&integer_info_g[1])
#define foo_sum_2 (void *)(&integer_info_g[2])
#define foo_a_3 (void *)(&integer_info_g[3])
#define foo_b_4 (void *)(&integer_info_g[4])
#define foo_asapra_return †
    (void *)(&integer_info_g[5])
```

The initialization and the software driver and functions in the RA model 450 for the example above may be as follows:

```
Initialization function
void foo_asapra_init( )
{
  set(foo_sum_2, 0);
}
Software driver function
int foo(int a, int b[10])
{
declare the function return variable
  declare(int, _funcret)
  out_scalar(foo_a_3, “a”);
  out_array_scalar(foo_b_4,
      “b”, 10);
  asapra_foo( );
  in_array_scalar(foo_b_4,
      “b”, 10);
  in_ret(foo_asapra_foo,
    &_funcret, “_funcret”);
  /* this is the return statement */
  return(_funcret);
}
```

The RA model function that performs the same computation as the original software implementation of function ‘foo’ may be as follows:

```
void asapra_foo(void)
{
  set(foo_sum_2, 0,0LL);
  set(foo_i_1, 0,0LL);
  while (get(foo_i_1, 0) < 10LL){
    set(foo_sum_2, 0,
      get(foo_sum_2, 0) +
        get(foo_a_3, 0) *
        get(foo_b_4,get(foo_i_1, 0)));
    set(foo_plusplus_0, 0,
        get(foo_i_1, 0));
    set(foo_i_1, 0,
        get(foo_plusplus_0, 0) + 1LL);
  }
  set(foo_asapra_return, 0,
      get(foo_sum_2, 0));
  return;
}
```

Results of implementing methods and systems described above may be illustrated with the following example. The example relates to a scanner program. In the program, an image is scanned and each pixel is converted to its RGB components, each of which may attain a value between 0 and 255. The scanner optics quality is not very good, and hence it is compensated with a software function to correct the color of each pixel, based on a reference black and white pixel. The exemplary program code is written in C, and it is compiled for the ARM940T platform by ARM, Ltd. The application is executed using the Seamless Co-verification Environment (CVE) by Mentor Graphics Corporation, and the performance profile (e.g., 460) is collected during the execution.

The original function for pixel correction, which corrects the color for one pixel, is as follows:

```
unsigned long fix_pixel(
unsigned long pixel,
unsigned long black,
unsigned long white)
{
int red, green, blue;
int r_min, r_max;
int g_min, g_max;
int b_min, b_max;
r_min = black >> 16 & 0xFF;
r_max = white >> 16 & 0xFF;
g_min = black >> 8 & 0xFF;
g_max = white >> 8 & 0xFF;
b_min = black >> 0 & 0xFF;
b_max = white >> 0 & 0xFF;
red = (pixel >> 16) & 0xFF;
green = (pixel >> 8) & 0xFF;
blue = pixel & 0xFF;
red = (red − r_min)*(256 * 255 /
  (r_max − r_min));
green = (green − g_min)*(256 * 255 /
  (g_max − g_min));
blue = (blue − b_min)*(256 * 255 /
  (b_max − b_min));
red = red >> 8;
green = green >> 8;
blue = blue >> 8;
return ((red << 16) +
  (green << 8) +
  blue);
}
```

A bit-width report generated with respect to the exemplary program above is shown in Table 1, below. The report shows that only 16-bits are used by the variables, ‘green’, ‘blue’ and ‘red’. Similarly there are some variables that use only 8-bits (‘r\min’, ‘r\_max’, ‘b\min’, ‘b\_max’, ‘g\min’ and ‘g\_max’).

TABLE 1

| Variable | Max | Min | BU | BD |
|---|---|---|---|---|
| pixel | 11206570 | 11206570 | 32* | 32 |
| black | 21760 | 21760 | 16* | 32 |
| white | 11206570 | 11206570 | 32* | 32 |
| green | 65280 | 255 | 16 | 32 |
| blue | 65280 | 170 | 16 | 32 |
| red | 65280 | 170 | 16 | 32 |
| r_min | 0 | 0 | 1 | 32 |
| r_max | 170 | 170 | 8 | 32 |
| g_min | 85 | 85 | 7 | 32 |
| g_max | 255 | 255 | 8 | 32 |
| b_min | 0 | 0 | 1 | 32 |
| b_max | 170 | 170 | 8 | 32 |

[Legend: BU: Bits Used; BD: Bits Declared]

Based on the bit-width report (Table 1 above) the original code above may be modified, by changing the types of the variables as shown next. The types of variables red, green and blue may be specifically declared to have a bit-width of 16 bits, while the others may be declared with a bit-width of 8 bits.
unsigned int# 16 red, green, blue;
unsigned int#8 r_min, r_max;
unsigned int#8 g_min, g_max;
unsigned int#8 b_min, b_max;

To compare area related to original software implementation and the one modified with bid-width specified based on the report (Table 1) may both be synthesized to an RTL description in VHDL, for instance. The RTL may then be input to a EDA tool such as Synopsys® Design Compiler. The resulting area reports for the original code and the bid-width specified code is shown in Table 2 and Table 3, respectively.

TABLE 2

| Area Type | Original Function |
|---|---|
| Combinatorial | 125156.000 |
| Non-combinatorial | 3500.000 |
| Cell Area | 128656.000 |

TABLE 3

| Area Type | Modified Function |
|---|---|
| Combinatorial | 20767.000 |
| Non-combinatorial | 2387.000 |
| Cell Area | 23154.000 |

The results indicate the savings in the combinatorial area are substantial. This is mainly because the size of the multipliers and dividers are much smaller. The savings in the register area are also reasonable (about 30%).

### Example of an Embodiment of a Register Analyzer

The following describe an exemplary implementation of a tool for determining optimal sizes of variables of a program. The details herein are only provided to fully describe the example and do not in any manner limit the invention disclosed herein. The ASAP software from Mentor Graphics Corporation provides a structured method to convert software written in C to hardware. The ASAP C language extends ANSI C in several ways. One of these is the Integer Data Type Extensions, which allows the user to specify the width of a signed or unsigned integer. This extension can be used to reduce the size of the hardware generated by the ASAP tools.

In the ASAP 1.2.0 release, a user must manually inspect the variables of integer type and determine whether any of them can be declared with a shorter width. This may be simple to do for relatively small programs. However, for larger programs, it will be useful to have software tools that will report the maximum and minimum value assumed by each integer type variable. This document below, describes a functional specification for an example of such a tool, which is henceforth referred to as the Register Analyzer.

Henceforth, the document will refer to these following terms as described below:
integer type: This will refer to signed and unsigned integer types, that are represented in C using char, short, int, long
A variable of integer type will include C variables of integer type, integer type members of a C structure, and integer type elements of a C array
ASAPRA—Register Analyzer Tool
   ASAPS—A hardware compiler tool by Mentor Graphics Corporation.

The use of appropriate number of bits for a variable can have a significant impact on the area. Specifying a smaller width impacts the size of the variable, and the size of various functional units. This is demonstrated in the following example:

```
#define MAX 80
int circuit(int a[MAX], int b[MAX], int c[MAX])
{
  int i, temp, sum = 0;
  for(i = 20; i < MAX; i++) {
    temp = b[i] * c[i];
    sum += temp;
    a[i] += temp;
  }
}
```

The functional units generated for this code and their area are:
FU: MULT\_SGN32\_{—}32\_{—}32 (Area=3252.90)=1
FU: ADD32 (Area 105)=2
FU: CMP\_SGN32 (Area 103)=1

The statistics on total area for implementing the above code in hardware may be as follows:
Total area=5028
Combinatorial area=3831
Register area=1197
Number of flip-flops=171

Consider a scenario, where the user knows that values of a, b, c, i, temp, sum can be stored within 17-bits. The program may be modified as follows:

```
#include “asap_types.h”
#define MAX 80
int17 circuit(int17 a[MAX], int17 b[MAX], int17 c[MAX])
{
  int17 i, temp, sum = 0;
  for(i = 20; i < MAX; i++) {
    temp = b[i] * c[i];
    sum += temp;
    a[i] += temp;
  }
}
```

The functional units generated for this code and their area may be:
FU: MULT\_SGN17\_{—}17\_{—}17 (Area=885.10)=1
FU: ADD17 (Area 60)=2
FU: CMP\_SGN17 (Area 54)=1

The statistics on total area now may be:
Total area=1907
Combinatorial area=1229
Register area=679
Number of flip-flops=97

As shown above, the combinatorial area has reduced by a factor of 3, and the register area by about 1.8, and the total area by a factor of about 2.6. The above example has been specifically constructed to demonstrate the differences in areas, by changing the bit widths.

The ASAPRA tool will help users to accomplish the task of determining the appropriate bit widths of the variables being used in the program.

The ASAPS program may be used to convert the original software code implementation of the function to a Register Analyzer (RA) model (e.g., 450) of the original function in software code (e.g., C). In this RA model, an assignment to an integer variable will be converted to a function that will also keep track of its maximum and minimum values. The details of the current value, source context, maximum and minimum values for each integer variable will be maintained in a data structure, that is described later.

The ASAPRA program will invoke ASAPS to generate the RA model. It will compile the RA model, and link it with a new library. The resulting program will be executed to generate a Register Analyzer (bit-width report), that will comprise the details of variables of program, and their respective maximum and minimum values. The stimulus for driving the RA model will be read from a performance profile (e.g., 460).

Pointer accesses (either external memory accesses or noreg memory accesses) in the original C function will be desirably supported by ASAPRA.

Desirably, the ASAPRA tool will support the following options:

asapra [-h | -help]

| [ -v \| -version ] | |
|---|---|
| [ -proj <project> ] | |
| [-ppdb <Input perf. database directory>] | |
| [-loggername <Logger names>] | |
| [-instname <Logger Instance Names>] | |
| -h \| -help : prints the usage | |
| -v \| -version | : prints the version |
| -proj <project> | : indicates the project name |

```
-ppdb <Input perf. database directory>
  Specifies the input PPDB to be used to drive
  the model
-loggername <Logger names>
-instname <Logger Instance Names>
  Indicate the logger and instance name(s).
```

Desirably, any of the options of ASAPS, can be provided on the command line of ASAPRA, and ASAPRA will invoke ASAPS with these command-line options.

The RA model will be compiled and linked with a static library. The library in one form desirably defines the following data structures and functions:

```
Data structures:
typedef long long intlimit_t;
typedef struct_integer_info_t {
  char *name;  /* Name of the variable */
  char  *filename; /* filename where variable
        is declared */
  int lineno;  /* Linenumber in file where
        variable is declared */
  intlimit_t *value;  /* Current value of variable */
  intlimit_t minimum;  /* Minimum value of variable */
  intlimit_t maximum;  /* Maximum value of variable */
  int size; /* Array size for arrays,
        1 for scalar */
  Int  elem_size;  /* Size of array element,
        for array variables.
            Size of scalar for
        scalar variables */
  int address;  /* Address of a noreg variable */
  char  flags_noreg:1;/* is variable noreg */
  char  flags_array:1;/* is variable an array */
  char  flags_kind:2; /* variable kind:
            local, parameter or global*/
  char  flags_size:1; /* Must bit width be suggested?
        Set to false for pointers */
  char  *valid /* valid[i] indicates if
            value[i] is valid */
  char  min_max_valid;/* Indicates if min and max
        are valid or not */
} integer_info;
Variables:
/* A global array of integer_info_t elements */
integer_info_t *integer_info_g;
/* Number of elements in the array */
Int  size_integer_info;
/* pointer to function returning int */
Int  (*topfunction_ptr)();
Functions:
intlimit_t get(integer_info_t *p, int index);
```

The function “get” will return the “value[index]” associated with p, taking into account the “elem\_size”. If the value is not valid (e.g., value has not yet been assigned locally to the function being evaluated), the value will be read from a performance profile database (PPDB e.g., 460) using an API (application programming interface). The API will be used to read the values of the parameters of the top level function and to read the value of any integer type local variable (other than a noreg integer type variable).
void set(integer_info_t *p, int index, intlimit_t value);

This function will set the “value[index]” associated with p. It will also set the minimum and maximum values, and update “valid”.
intlimit_t getmem(int address, int size);

This function will read the “value” of “size” bytes associated with “address”. If the value is not valid, it will be read from the PPDB, using the API. The “address” field will indicate the memory address to be read. This function will search the array integer\₁₃ info, to find the appropriate address.
void setmem(int address, int size, intlimit_t value);

This function will write “value” of “size” bytes to “address”. The function will also update the maximum and minimum values, and “valid”. The array integer\_info will have to be searched to find the address.

The new library will desirably implement the following functions for supporting the RA model.
1. asap_sem_lock
2. asap_sem_unlock
3. asap_out_scalar
4. asap_out_ptr
5. asap_out_array_scalar
6. asap_out_float
7. asap_out_float_array
8. asap_in_ret
9. asap_in_ret_float
10. asap_in_array_scalar
11. asap_in_float_array
12. asap_return
13. asap_fentry: To get the next invocation of the specified function in the PPDB, and set up to be able to drive the stimulus
14. print_ra_report: To print the Register Analyzer report
15. main: The main function will be implemented in the library. It will call (*topfunction_ptr) repeatedly, and finally print the report.

The behavior of the asap_out_* functions will typically be as follows:
1. Read data from the PPDB
2. Drive the RA model

All the asap_in_* and asap_sem_* functions will have empty bodies. The asap_out_* functions will use the “set” function described earlier.

A new option will be added to ASAPS to support the ASAPRA feature as follows:
-hwm, will indicate that ASAPS will be used to generate the the RA model. This option will be mutually exclusive with the existing options: -cac and -oformat. This option will be used internally by ASAPRA.

The files will be generated in the directory “proj/RA”:
1. cfunc_driver.c: This will contain a driver function.
2. cfunc_ra.c: This will contain the RA model for the top level function.
3. cfunc_ra.h: This will be a header file for the RA model.

An example program is shown next below. The contents of the files will be shown for this program. The line numbers are shown within brackets in the left:

```
[ 1] int g1 = 23;
[ 2]  int topfunction(int a, int b[23], short c)
[ 3]  {
[ 4]  int i = 0, j;
[ 5]  static struct _s1 { int a; int b; } s;
[ 6]  for(i = 0; i < 23; i++)
[ 7]  b[i] = b[i] * ( a + c);
[ 8]  if(b[0] > 17)
[ 9]  { j = a + 6; g1 = b[0]; }
[10]  else
[11]  j = c;
[12]  s.a = b[0]; s.b = b[22];
[13]  return (j + b[c]);
[14]  }
Contents of topfunction_driver.c
#include “topfunction_ra.h”
#include <asap_macros.h>
int topfunction(int a, int b[23], short c)
{
  /* declare the function return variable */
  asap_declare(int, _funcret)
  /* The variables to be passed to the ASAP hardware */
  asap_out_scalar(ASAP_topfunction_0a_0, a, “a”);
  asap_out_array_scalar(ASAP_topfunction_0b_1, \
      (int *)b, “b”, 23);
  asap_out_scalar(ASAP_topfunction_0c_2, c, “c”);
  ra_topfunction( );
  /* the values to be received from the ASAP hardware */
  asap_in_array_scalar(ASAP_topfunction_0b_1, \
      (int *)b, “b”, 23);
  asap_in_ret(ASAP_topfunction_0_4funcret, \
    &_funcret, “_funcret”);
  /* this is the return statement */
  asap_return(_funcret);
}
/* End of file topfunction_driver.c */
Contents of topfunction_ra.h
#ifndef topfunction_ra_included
#define topfunction_ra_included
extern integer_info_t *integer_info_g;
extern int size_integer_info;
extern (*topfunction_ptr)( );
#define ASAP_topfunction_0a_0 (void *)(&integer_info_g[0])
#define ASAP_topfunction_0b_1 (void *)(&integer_info_g[1])
#define ASAP_topfunction_0c_2 (void *)(&integer_info_g[2])
#define ASAP_topfunction_0g1_3 (void *)(&integer_info_g[3])
#define ASAP_topfunction_0i_4 (void *)(&integer_info_g[4])
#define ASAP_topfunction_0j_5 (void *)(&integer_info_g[5])
#define ASAP_topfunction_0s_4a_6 (void *)(&integer_info_g[6])
#define ASAP_topfunction_0s_4b_7 (void *)(&integer_info_g[7])
#endif
/* End of the file cfunc_ra.h */
Contents of topfunction_ra.c:
Note actual content of integer_info is not shown.
#include “topfunction_ra.h”
int size_integer_info = 8;
integer_info_t
integer_info[ ] = {
      { }, /* Initialization for a */
      { }, /* Initialization for b */
      { }, /* Initialization for c */
      { }, /* Initialization for g1 */
      { }, /* Initialization for i */
      { }, /* Initialization for j */
      { }, /* Initialization for s_a */
      { }, /* Initialization for s_b */
    };
int
ra_topfunction ( )
{
  set(ASAP_topfunction_0i_4, 0, i);
  set(ASAP_topfunction_0i_4, 0, i);
  while (get(ASAP_topfunction_0i_4,0) < 23) {
  set(ASAP_topfunction_0b_1, i,
    get(ASAP_topfunction_0b_1,i) *
    (get(ASAP_topfunction_0a_0,0) +
    get(ASAP_topfunction_0c_2,0))
    );
  set(ASAP_topfunction_0i_4, 0,
    get(ASAP_topfunction_0i_4) + 1);
  }
  if (get(ASAP_topfunction_0b_1,0) > 17) {
    set(ASAP_topfunction_0j_5, 0,
      get(ASAP_topfunction_0a_0,0) + 6);
    set(ASAP_topfunction_0g1_3, 0,
      get(ASAP_topfunction_0b_1,0));
  }
  else {
    set(ASAP_topfunction_0j_5, 0,
      get(ASAP_topfunction_0c_2,0);
  }
    set(ASAP_topfunction_0s_4a_6, 0,
      get(ASAP_topfunction_0b_1,0));
    set(ASAP_topfunction_0s_4b_7, 0, s_b,
      get(ASAP_topfunction_0b_1,22));
    return (get(ASAP_topfunction_0j_5, 0) +
      get(ASAP_topfunction_0b_1,c));
  }
  int ra_top( )
  {
    while (asap_fentry( ) == 0) {
      topfunction( );
      return 0;
    }
    print_ra_report( );
    return 1;
}
Topfunction_ptr = ra_top;
```

ASAPRA will desirably display its report on the screen. The report will desirably also be stored in the file in a file name as follows:
<project>/sim/RA/<cfunc>_<ppdb>.rep
   where cfunc is the name of the top level function, and ppdb is the name of the ppdb used.

The output format of the report generated by ASAPRA, is described below, for the sample C program, as shown below. The line numbers are shown within brackets in the left:

[ 1] int g1 = 23;
[ 2] int topfunction(int a, int b[23], short c)
[ 3] {
[ 4] int i = 0,j;
[ 5] static struct_s1 { int a; int b; } s;
[ 6] for(i = 0; i < 23; i++)
[ 7] b[i] = b[i] * (a + c);
[ 8] if(b[0] > 17)
[ 9] { j = a + 6; g1 = b[0]; }
[10] else
[11] j = c;
[12] s.a = b[0]; s.b = b[22];
[13] return (j + b[c]);
[14] }

TABLE 4

| File- | | | Vari- | | Max- | | Bits |
|---|---|---|---|---|---|---|---|
| name | Function | Line | able | Type | imum | Minimum | Used |
| a.c | topfunction | 1 | g1 | global | 1200 | −1189 | 11 |
| a.c | topfunction | 2 | a | param | 1331 | 311 | 11 |
| a.c | topfunction | 2 | b | param | 30000 | −65536 | 16 |
| a.c | topfunction | 2 | c | param | 619 | −490 | 10 |
| a.c | topfunction | 4 | i | local | 23 | 0 | 5 |
| a.c | topfunction | 4 | j | local | 1337 | −484 | 11 |
| a.c | topfunction | 5 | s.a | local | 1337 | −23 | 11 |
| a.c | topfunction | 5 | s.b | local | 1100 | 221 | 11 |

Note that for an array in the specific example, the maximum value represents the maximum value among all elements of the array. Similarly, the minimum value represents the minimum value among all elements of the array.

The column, Bits Used, is the minimum number of bits needed to represent the entire range of values of the variable. Bits Used=maximum(Bits needed to represent Maximum value, Bits needed to represent Minimum value)

For example:
Variable b: Bits for maximum value (30000)=15
   Bits for minimum value (−65536)=16
Bits Used=16

The ASAPRA uses the PPDB to determine the maximum and minimum values. It can compare the output of the functions with the expected values, and thus provide a verification mechanism. The ASAPRA feature may be used to automatically determine the maximum and minimum values of any and/or all types of variables in the function being converted to hardware. The user will desirably do two things manually to reduce the size of the hardware generated by ASAPS, after using the ASAPRA feature.

1. The maximum and minimum values are reported with respect to a given performance profile (e.g., PPDB). The user may check whether a variable will assume the same range of values, as reported by the RA model, for all PPDBs.

2. Change the type of the variable and use a width that is adequate to hold the entire range of values that may be assumed by the variable.

Desirably, the ASAPRA tool may also check two kinds of errors:

1. Check for uninitialized variables: It can determine if a variable was read using “get”, prior to any call to “set”. It will report a warning message for any uninitialized access.

2. Check for overflow: It can check whether the maximum and minimum values will fit within the bit widths specified, and report a warning otherwise.

The ASAPRA Feature is expected to be used primarily with ANSI C programs. However, users of the tool may want to take advantage of the extensions supported by ASAP C: Integers of arbitrary width, parallelization and synchronization constructs. These extensions are expected to be coded using the pre-processing construct “#ifdef ASAPS”. These constructs are desirably supported:
Largest bit width of any local variable in the C function will be 64. This limitation can be removed, if required, since it requires support for arbitrarily large integers.
The parallelization constructs will be supported, without limitations.
The synchronization constructs, using Synchronous channels and the send and receive functions will be supported.

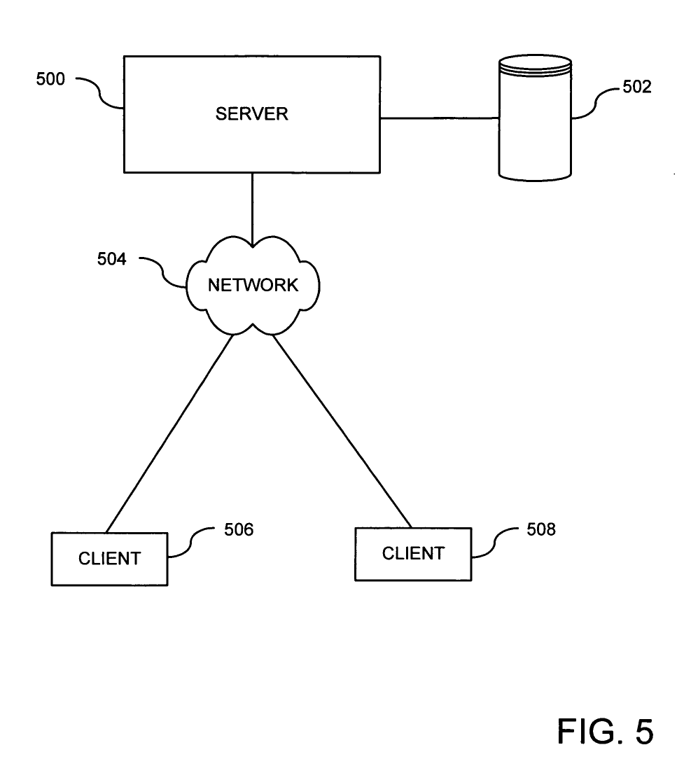

Any of the aspects of the technology described above may be performed or designed using a distributed computer network. FIG. 5 shows one such exemplary network. A server computer 500 can have an associated storage device 502 (internal or external to the server computer). For example, the server computer 500 can be configured to apply probe functions to a software code representation to determine optimal sizes of selected variables therein using any of the embodiments described above. This may result in a reduction in the area related to an actual hardware implementation of the software. The server computer 500 may be coupled to a network, shown generally at 504, which can comprise, for example, a wide-area network, a local-area network, a client-server network, the Internet, or other such network. One or more client computers, such as those shown at 506, 508, may be coupled to the network 504 using a network protocol.

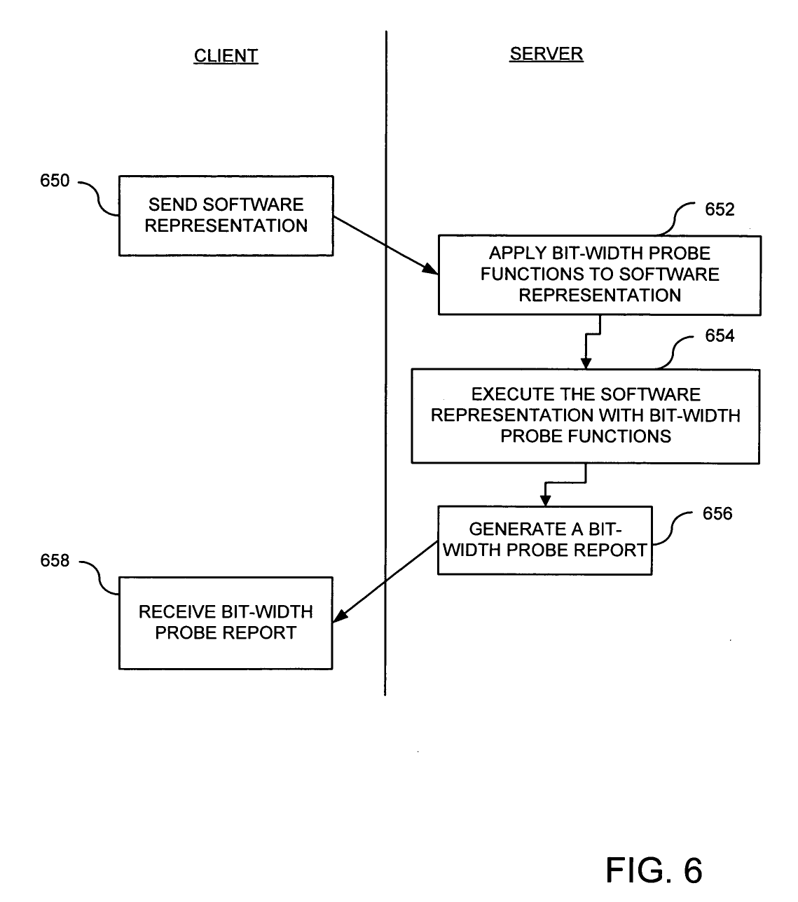

FIG. 6 illustrates an exemplary implementation of methods described above in a client-server environment. At 650, a client computer may send software code representation to a server. At 652, the server computer may apply bit-width functions to the software code to determine values attained by variables comprised therein. Then at 654, the software code representation with bit-width probe functions applied therein is executed to determine a minimum value and a maximum value and desirably a current value of selected variables. At 656, at least in part, based on the values determined at 654, a bit-width report comprising hints with suggestions of optimal bit-widths for at least one of the selected variables is generated. At 658, the bit-width report is received and the software code representation may be modified to specify at least one of the suggested bit-width to generate a software code optimized representation that will result in reduced area when implemented in actual hardware.

Having illustrated and described the principles of the illustrated embodiments, it will be apparent to those skilled in the art that the embodiments can be modified in arrangement and detail without departing from such principles. In view of the many possible embodiments to which the principles of the disclosed invention might be applied, it should be recognized that the detailed embodiments are illustrative only and should not be taken as limiting the scope of the invention. Rather, we claim as our invention all such embodiments as may come within the scope and spirit of the specification and equivalents thereto.

1. A method for determining optimal sizes of variables comprising a computer program, the method comprising:
applying probes to record values attained by at least one variable of the computer program;
based on the recorded values of the at least one variable, determining at least a minimum number of bits needed to express the recorded values of the at least one variable; and
based on the at least minimum number of bits needed to express the recorded values of the at least one variable determining an optimal size for the at least one variable.

2. The method of claim 1, wherein applying probes to record values attained by the at least one variable comprises maintaining a record of a minimum value attained by the at least one variable and maintaining a record of a maximum value attained by the at least one variable.

3. The method of claim 2, wherein determining the at least minimum number of bits needed to express the recorded values of the at least one variable of the computer program further comprises determining the minimum number of bits needed to express both the minimum and maximum values attained by the at least one variable.

4. The method of claim 1, wherein applying the probes to record values attained by the at least one variable of the computer program comprises converting an original form of the computer program representation to a probe-applied representation of the computer program.

5. The method of claim 4, wherein the probe-applied representation of the computer program comprises one or more functions calls adapted for maintaining a record of a minimum and a maximum value attained by the at least one variable of the computer program.

6. The method of claim 5, wherein determining the at least minimum number of bits needed to express the recorded values of the at least one variable of the computer program comprises executing the probe-applied representation of the computer program.

7. The method of claim 6, wherein the execution of the probe-applied representation of the computer program is driven by test bench data provided by a performance profile database comprising data collected from a previous execution of the computer program.

8. The method of claim 6, wherein the one or more function calls refer to software code associated with a software function library comprising software code related to functions operable for maintaining a record of a minimum and a maximum value attained by the at least one variable of the computer program.

9. The method of claim 6, wherein the one or more function calls refer to software code within the probe-applied representation of the computer program adapted for maintaining a record of a minimum and a maximum value attained by the at least one variable of the computer program.

10. The method of claim 1, further comprising: generating a bit-width report comprising hints of at least one bit-width related to the optimal size for the at least one variable.

11. An apparatus for optimizing area needed for hardware implementation of an algorithm, the apparatus comprising:
a register analyzer operable for initiating execution of at least some portion of a software implementation of the algorithm and maintaining a record of a minimum value and a maximum value attained by at least one variable of the at least some portion of the software implementation of the algorithm as a result of execution of the at least some portion of the software implementation of the algorithm;
a performance profile database comprising test bench data for driving the execution of the at least some portion of the software implementation of the algorithm; and
a probe function library comprising software code related to probe functions to be invoked by the register analyzer for maintaining the record of the minimum value and the maximum value attained by the at least one variable of the software implementation of the algorithm.

12. The apparatus of claim 11, wherein the at least some portion of the software implementation of the algorithm is adapted to comprise probe function calls for maintaining a record of a minimum value and a maximum value attained by the at least one variable of the at least some portion of the software implementation of the algorithm.

13. The apparatus of claim 11, wherein the performance profile database is generated by simulating the execution of the software implementation of the program.

14. The apparatus of claim 11, wherein the register analyzer is further operable for generating a bit-width report comprising hints for optimal bit-width sizes sufficient to express values attained by the at least one variable of the at least some portion of the software implementation of the algorithm as a result of the execution of the at least some portion of the software implementation of the algorithm.

15. The apparatus of claim 14, wherein the bit-width report comprises at least a maximum value, and a minimum value data field respectively related to the at least one variable of the at least some portion of the software implementation of the algorithm.

16. A computer implemented method for generating an area optimized hardware implementation of selected functionalities of an electronic system, the method comprising:
selecting at least one portion of a software implementation of the selected functionalities of the electronic system;
maintaining a record of at least one minimum value and one maximum value attained by at least one corresponding variable related to the at least one portion of the software implementation as a result of the execution of the at least one portion of the software implementation; and
based at least on the at least one minimum value and the at least one maximum value attained by the at least one corresponding variable related to the at least one portion of the software implementation, determining at least one optimal bit-width for the at least one corresponding variable.

17. The method of claim 16, wherein maintaining the record of at least one minimum value and one maximum value attained by the at least one corresponding variable related to the at least one portion of the software implementation as the result of the execution of the at least one portion of the software implementation comprises compiling the at least one portion of the software implementation of the selected functionalities of the electronic system to a register analyzer version of the software implementation of the selected functionalities and executing the register analyzer version of the software implementation of the selected functionalities.

18. The method of claim 17, wherein the register analyzer version of the software implementation of the selected functionalities comprises function calls for updating data structures related to maintaining the record of the at least one minimum value and the at least one maximum value attained by the at least one corresponding variable related to the at least one portion of the software implementation as the result of the execution of the at least one portion of the software implementation.

19. The method of claim 17, wherein the function calls for updating the data structures related to maintaining the record of the at least one minimum value and the at least one maximum value attained by the at least one corresponding variable refer to a library of probe functions.

20. The method of claim 17, wherein the execution of the register analyzer version of the software implementation of the selected functionalities is driven at least partially by data from a performance profile database comprising data from a previous execution of the software implementation of the selected functionalities of the electronic system.

21. The method of claim 16, further comprising modifying the at least one portion of the software implementation by specifying the optimal bit-width for the at least one corresponding variable.

22. The method of claim 21, further comprising synthesizing the modified portion of the software implementation to generate an area optimized hardware implementation of the at least one portion of the software implementation of the system functionality.

23. The method of claim 16, further comprising generating a bit-width report including hints indicative of the at least one optimal bit-width determined for the at least one corresponding variable.
